(19) United States
(12) Patent Application Publication
(10) Pub. No.: US 2020/0038975 A1
(43) Pub. Date: Feb. 6, 2020

(54) CUTTING DISK

(71) Applicant: Albert Knebel Holding GmbH, Balingen (DE)

(72) Inventors: Philipp Woermann, Rietberg (DE); Guenter Hermbusche, Hoevelhof/Riege (DE)

(73) Assignee: Albert Knebel Holding GmbH, Balingen (DE)

(21) Appl. No.: 16/530,272

(22) Filed: Aug. 2, 2019

(30) Foreign Application Priority Data
Aug. 3, 2018 (DE) 10 2018 118 959.1

(51) Int. Cl. B23D 3/02

(52) U.S. Cl. CPC B23D 3/02

(57) ABSTRACT

A cutting disk for workpieces, particularly workpieces of fiber-reinforced composite materials, has a base body which is provided at least in some areas with a circumferential toothing and with a flank toothing arranged on at least some areas and on at least one lateral surface. At least with the majority of circumferential teeth, the main cutting edges do not directly encounter the main cutting edges of the adjacent flank teeth, and the main cutting edges accordingly do not define a common rake face.

### CROSS-REFERENCE TO RELATED APPLICATIONS

This application claims priority under 35 USC 119 of German Application No. 10 2018 118 959.1, filed on Aug. 3, 2018, the disclosure of which is herein incorporated by reference.

### BACKGROUND OF THE INVENTION

The invention is directed to a cutting disk for cutting and/or making grooves in workpieces, particularly workpieces of fiber-reinforced composite materials, with a disk-shaped base body which is provided at least in some areas with a circumferential toothing and with a flank toothing which is arranged at least in some areas at least on one lateral surface.

At the present time, various tools are used to machine composite structural component parts of fiber-reinforced composite materials. End mills of cemented carbide or cemented carbide saws or saws with soldered polycrystalline diamonds with conventional tooth geometries are used. It is also possible to use diamond-coated cutting disks with an indeterminate cutting geometry. However, the cut quality in the disk-shaped tools employed heretofore for machining fiber-reinforced composite materials is unsatisfactory.

### SUMMARY OF THE INVENTION

Therefore, it is an object of the invention to provide a cutting disk with which an excellent cut quality can be achieved without delamination or fiber protrusion, even with composite structural component parts of fiber-reinforced composite materials, which are difficult to machine.

The above-stated object is met by a cutting disk for cutting and/or making grooves in workpieces, particularly workpieces of fiber-reinforced composite materials, with a disk-shaped base body which is provided at least in some areas with a circumferential toothing and with a flank toothing which is arranged at least in some areas at least on one lateral surface. According to the invention, this cutting disk is characterized in that, at least with the majority of teeth of the circumferential toothing, the main cutting edges of the teeth of the circumferential toothing do not directly encounter the main cutting edges of the flank toothing such that the main cutting edges of the teeth of the circumferential toothing and the main cutting edges of the teeth of the flank toothing do not form a common rake face.

As a result of this offset of the main cutting edges of the circumferential toothing and of the flank toothing, there is a decoupling of functionalities of the circumferential toothing and flank toothing. By contrast, in a circumferential toothing provided in the commercially available saws, the teeth comprise a main cutting edge and at least one secondary cutting edge, and the secondary cutting edges of the teeth form a flank toothing. The main cutting edge and secondary cutting edge meet in a corner point of the tooth and jointly define a plane which forms the rake face. Accordingly, some angles of the main cutting edge and secondary cutting edge are mutually dependent. The rake angle of the main cutting edge determines the shape of the secondary cutting edge. The axis angle of the main cutting edge, i.e., the angle of the main cutting edge to the axial direction of the cutting disk, in turn determines the wedge angle of the secondary cutting edge. Therefore, the orientation of the main cutting edge and secondary cutting edge cannot simultaneously be optimally adjusted to the respective machining task.

This is sometimes remedied by providing the cutting disk with different tooth groups, wherein the teeth within one group are configured such that the angles are optimized for the main cutting edge and, in another group, the angles of the secondary cutting edge are optimized. The cutting edge of a tooth, i.e., main cutting edge or secondary cutting edge, in which the angles are not ideal for the current use, is deactivated, for example, by grinding back within a group.

Therefore, only main cutting edges and secondary cutting edges with ideal cutting angles contribute to forming the surface of the workpiece. With this method, however, a great many more teeth in total must be arranged on the cutting disk in order to achieve the same cutting speed. By contrast, in the solution according to the invention, teeth which are all configured with ideal angles for circumferential machining can be arranged at the circumference by means of the decoupling of the main cutting edges of the circumferential toothing and flank toothing. At the same time, the main cutting edges of the flank toothing of the cutting disk can also be adapted to the requirements of the machining task, and the cutting surface quality of the workpiece can be appreciably enhanced.

The teeth of the circumferential toothing and the teeth of the flank toothing can each have at least one secondary cutting edge, and these secondary cutting edges do not participate in the machining process. The secondary cutting edges of circumferential teeth and flank teeth can have mutual intersections. This does not interfere with the optimal orientation of the main cutting edges because the secondary cutting edges do not participate in the machining process.

The flank toothing can preferably be arranged in the radially outer area of the base body of the cutting disk. Accordingly, the main cutting edges of the flank teeth take effect immediately after or immediately before the circumferential toothing engages in the workpiece. In this way, particularly when cutting grooves, sharp-edged groove profiles can be produced.

The flank toothing can be provided with identical flank teeth or with groups of identical or different flank teeth. The flank teeth of different groups can differ from one another particularly in the orientation of the main cutting edges. However, to achieve a good cut quality, it is not absolutely necessary that the flank edges are formed without gaps over the entire circumference of the cutting disk. It is also possible to provide individual groups of flank teeth. In this configuration, the temperature can be reduced during machining. However, the groups can also be arranged adjacent to one another without gaps or can merge one into the other.

The main cutting edges of the flank teeth can preferably be arranged at a rake angle of from −5° to +5° to the radial direction of the cutting disk. These angle settings give the best cut qualities. If different groups of flank teeth are provided, the main cutting edges of the flank teeth can form a positive angle in some groups and the flank teeth of another group can have a negative angle with the radial direction of the cutting disk.

Further advantages are afforded when a free surface of a flank tooth transitions into the gullet space of the next flank tooth at least within one group. A contact of the workpiece with the base body itself can be prevented in this way even with five-axis movements.

Further advantages can be afforded particularly with respect to reducing the temperatures occurring during the cutting process in that notches or cutouts are arranged at the outer circumference of the cutting disk.

The circumferential toothing of the cutting disk can also be formed either by identical circumferential teeth or by groups of different circumferential teeth. In particular, the circumferential teeth can be optimized by their orientation such that an optimal quiet running of the cutting disk can be achieved. This can be achieved, for example, in that the main cutting edges of the circumferential teeth are arranged at an angle to the axial direction of the cutting disk. If a plurality of different groups of circumferential teeth is provided, the main cutting edges of these groups can form different angles with the axial direction of the cutting disk in each instance.

The diameter of the cutting disk can preferably amount to a multiple of its thickness. The ratio between diameter and thickness can vary depending on the purpose of use. Further, the cutting disk can have either a cylindrical shape or also, for example, a frustum shape. Moreover, the base body can be provided with a recess between its central axis and the flank toothing. The quiet running and noise development of the cutting disk can be further influenced in this way.

The cutting disk can be produced from a solid material. However, the tooth body and base body can also be separate component parts. In this respect, it is advantageous when the teeth of the circumferential toothing and the teeth of the flank toothing are made from cemented carbide or diamond and accordingly have a long service life. The circumferential teeth and/or the flank teeth can be soldered or glued or fastened to the base body by means of another suitable positive engagement or bonding engagement. Further, it is also possible to form the teeth of the circumferential toothing and the teeth of the flank toothing on common tooth bodies.

The cutting disk according to the invention can be used in five-axis machining equipment. Heretofore, five-axis machining of fiber-reinforced composite materials was possible only with end mills. However, it has been shown that such machining is also possible when using a cutting disk according to the invention.

### BRIEF DESCRIPTION OF THE DRAWINGS

Various embodiment examples of cutting disks according to the invention will be described more fully in the following with reference to the drawings. In the drawings,

FIGS. 1, 1a shows a view of a first cutting disk with a perspective detail view;

FIG. 2 shows a second, enlarged partial view of the toothing of the cutting disk from FIG. 1;

FIG. 3 shows a section of a flank toothing of a second cutting disk;

FIG. 4 shows a perspective partial view of the cutting disk from FIG. 3; and

FIG. 5 shows a view of a third cutting disk.

### DETAILED DESCRIPTION OF THE EMBODIMENTS

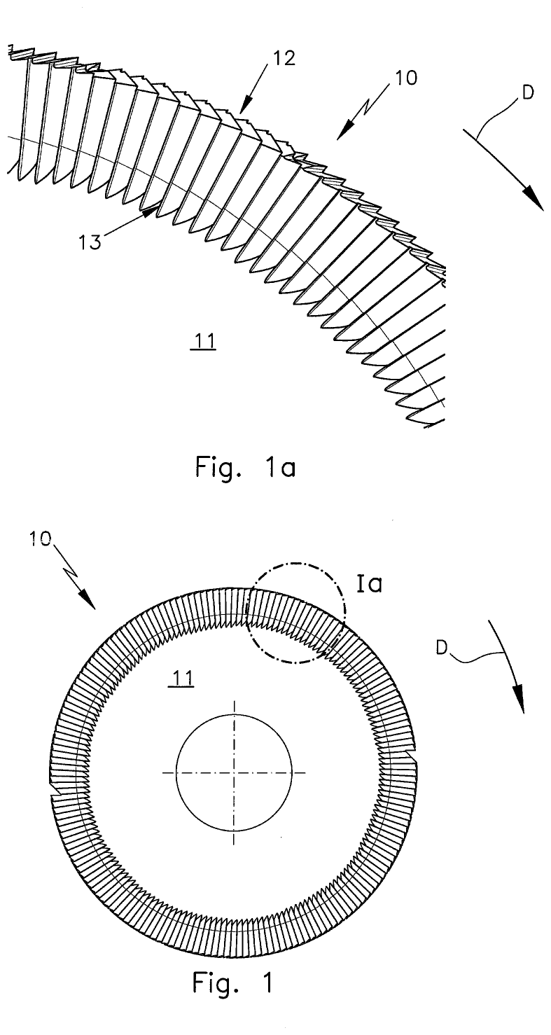

The cutting disk 10 in FIGS. 1, 1a has a base body 11, a gapless circumferential toothing 12 and a gapless flank toothing 13. The flank toothing 13 is located in the outer radial area of the base body 11 and directly adjoins the circumferential toothing 12. The rotational direction of the cutting disk 10 and of the cutting disks in the other figures is indicated in each instance by an arrow D.

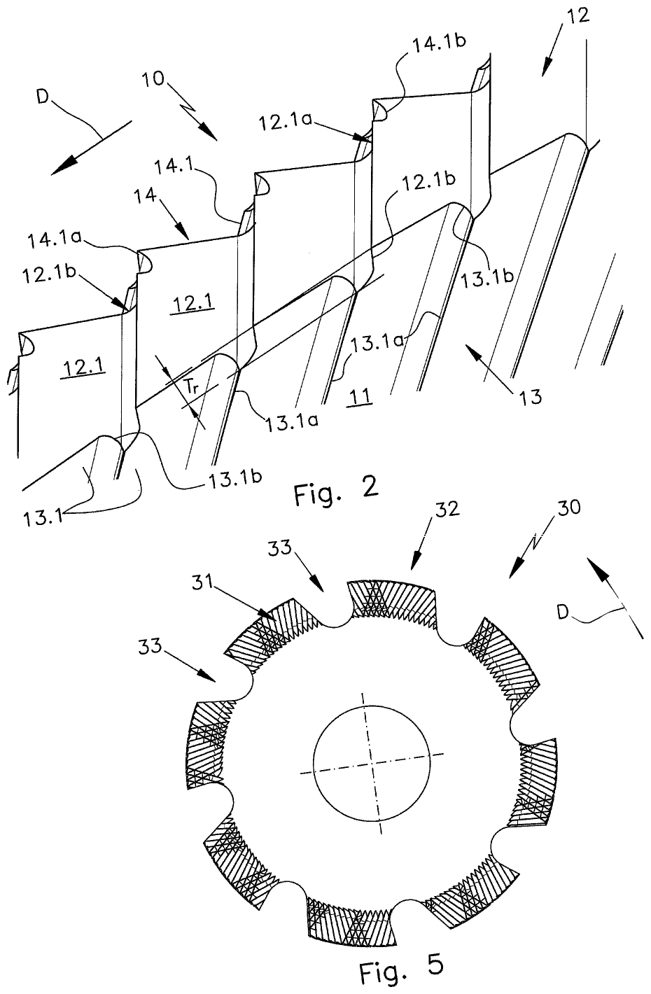

The detail view of the toothing of the cutting disk 10 in FIG. 2 looking at the opposite lateral surface shows that the base body 11 is also provided with a flank toothing 14 on its opposite lateral surface. The detail view in FIG. 2 further shows that the circumferential toothing 12 is formed by a plurality of circumferential teeth 12.1, and every circumferential tooth 12.1 has a main cutting edge 12.1a and two secondary cutting edges 12.1b. The flank toothing 13, on the other hand, is formed by a plurality of identical flank teeth 13.1 having a main cutting edge 13.1a and a secondary cutting edge 13.1b. Also, teeth 14.1 of flank toothing 14 are provided in each instance with a main cutting edge 14.1a and a secondary cutting edge 14.1b. The main cutting edges 12.1a of the circumferential toothing 12 and the main cutting edges 13.1a and 14.1a of the flank toothings 13, 14 have no common intersection. Rather, they are spaced apart by a spacing Tr. This makes it possible to select the cutting angles of the main cutting edges 12.1a of the circumferential toothing 12 and the cutting angles 13.1a, 14.1a of the flank toothings 13 and 14 completely independently from one another and, accordingly, to adjust optimal cutting edge angles for all three toothings 12, 13 and 14. Further, it will be appreciated from FIG. 2 that none of the secondary cutting edges 12.1b, 13.1b and 14.1b in cutting disk 10 participate in the machining process.

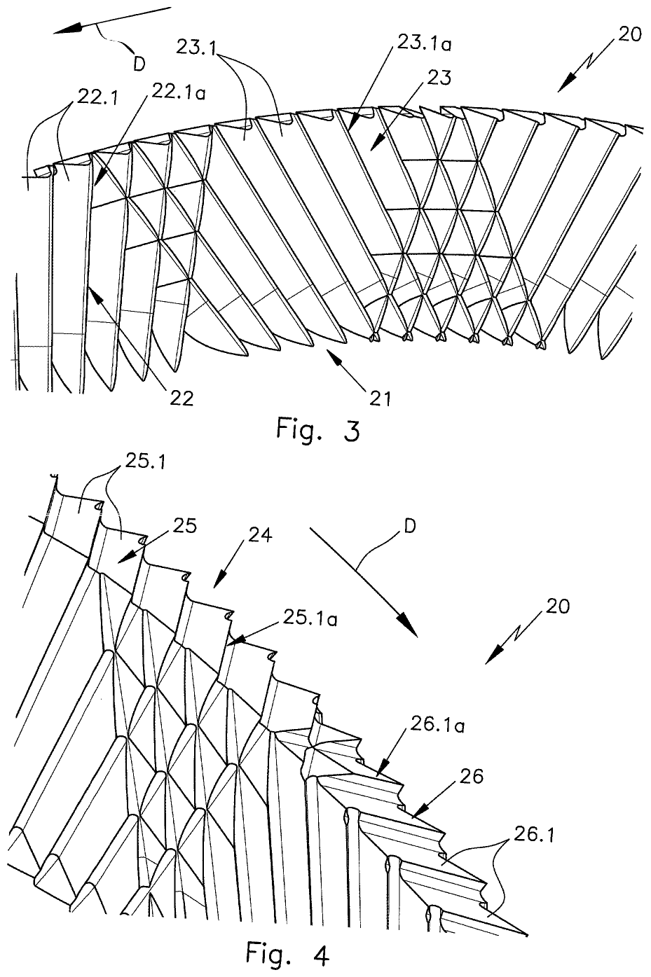

FIGS. 3 and 4 show a further variant of a cutting disk 20 in which a flank toothing 21 is divided into different groups 22, 23 according to FIG. 3, wherein teeth 22.1 and 23.1 of groups 22 and 23 differ with respect to the orientation of their main cutting edges 22.1a and 23.1a.

A circumferential toothing 24 of cutting disk 20 is also divided into different groups 25, 26 as is illustrated in FIG. 4. Teeth 25.1, 26.1 of groups 25 and 26 also have different orientations of the main cutting edges 25.1a and 26.1. In cutting disk 20, groups 22, 23 of flank toothing 21 and groups 25, 26 of circumferential toothing 24 are arranged adjacent to one another without gaps. However, this is not compulsory. They could also be arranged so as to be spaced apart from one another.

FIG. 5 shows a third embodiment form of a cutting disk 30 which corresponds to cutting disk 20 with respect to its flank toothing 31 and its circumferential toothing 32. However, cutouts 33 which are intended to counteract overheating of the workpiece during the cutting process are provided at regular intervals along the circumference of cutting disk 30.

What is claimed is:

1. A cutting disk for cutting and/or making grooves in workpieces, comprising:
a disk-shaped base body which is provided at least in some areas with a circumferential toothing and with a flank toothing which is arranged on at least some areas of the base body and on at least on one lateral surface of the base body, wherein with at least a majority of teeth of the cutting disc, main cutting edges of the teeth of the circumferential toothing do not directly encounter main cutting edges of the flank toothing such that the main cutting edges of the teeth of the circumferential toothing and the main cutting edges of the teeth of the flank toothing do not form a common rake face.

2. The cutting disk according to claim 1, wherein the teeth of the circumferential toothing and the teeth of the flank toothing each have at least one secondary cutting edge, wherein the secondary cutting edges do not participate in a machining process.

3. The cutting disk according to claim 1, wherein the flank toothing is arranged in a radially outer area of the base body of the cutting disk.

4. The cutting disk according to claim 3, wherein the flank toothing has identical flank teeth or groups of identical or different flank teeth.

5. The cutting disk according to claim 4, wherein the flank teeth are arranged in groups and wherein the groups of flank teeth are arranged with differently formed flank teeth to adjoin one another without gaps or to be spaced apart from one another.

6. The cutting disk according to claim 1, wherein the base body is provided with the flank toothing on both lateral surfaces, wherein the flank toothings of the two lateral surfaces are configured differently or identically.

7. The cutting disk according to claim 1, wherein the flank toothing is configured such that a free surface of a flank tooth transitions into a gullet space of a next flank tooth.

8. The cutting disk according to claim 1, wherein notches or cutouts are arranged at an outer circumference of the cutting disk.

9. The cutting disk according to claim 1, wherein the circumferential toothing is formed by identical circumferential teeth or by groups of different circumferential teeth.

10. The cutting disk according to claim 1, wherein the main cutting edges of the circumferential teeth are arranged at an angle to an axial direction of the cutting disk.
